(19) United States
(12) Patent Application Publication
(10) Pub. No.: US 2026/0367957 A1
(43) Pub. Date: Nov. 19, 2026

(54) ENSURING PRECOPY CONVERGENCE

(71) Applicant: MELLANOX TECHNOLOGIES, LTD., Yokneam (IL)

(72) Inventors: Gal Shalom, Givat-Avni (IL); Artem Polyakov, New York, NY (US); Asaf Shwartz, Tel Aviv (IL); Liran Liss, Atzmon-Segev (IL); Aviad Shaul Yehezkel, Yokneam Illit (IL)

(21) Appl. No.: 19/364,458

(22) Filed: Oct. 21, 2025

Related U.S. Application Data
(60) Provisional application No. 63/806,943, filed on May 16, 2025.

(51) Int. Cl. G06F 9/455

(52) U.S. Cl. CPC G06F 9/45558; G06F 2009/4557; G06F 2009/45591

(57) ABSTRACT

Approaches in accordance with various illustrative embodiments provide for the live migration of virtual resources. In order to minimize the amount of time in which a virtual resource will be unavailable during a migration, an attempt can be made to pre-copy as much data for the virtual resource as possible from a current host to a new host. Since the virtual resource is still operational, some of the data may be updated during the pre-copy phase which may require additional pre-copy iterations. In order to ensure that the rate of generation of “dirty” data is less than the data transfer rate during pre-copy, a dirty data rate limit can be applied. Since certain devices may not be able to be rate-limited, or because incoming data rates may not allow for such limiting without risk of data loss, there can be limits in place on aspects such as bandwidth and communication speed, which can effectively limit the rate of generation of dirty data for these devices.

### CROSS-REFERENCE TO RELATED APPLICATIONS

This application claims priority to U.S. Provisional Patent Application Ser. No. 63/806,943, filed May 16, 2025, and entitled “Ensuring Precopy Convergence,” Attorney Docket Number 778139.007301, which is hereby incorporated herein in its entirety and for all purposes.

### TECHNICAL FIELD

This disclosure relates generally to the management of computing resources, and in at least one embodiment relates to the live migration of computing resources in a complex computing environment, such as a datacenter.

### BACKGROUND

As compute jobs continue to increase in size and complexity, the size and complexity of the computing systems needed to perform these jobs is increasing as well. In many instances, a number of computing resources (e.g., physical or virtual compute resources) may be used together in a distributed manner to perform various portions of such a job. These resources may include a number of virtual machines (VMs), for example, that are hosted on a number of different physical resources, and that may communicate with a number of other resources or devices. At various times, it may be necessary to migrate some of these virtual resources to other physical resources, oftentimes while the virtual resources are active and available for processing by a user. During such a “live” migration, it can be desirable to minimize the length of time in which virtual resource is unavailable. Accordingly, various approaches allow for copying at least a portion of the state data for a virtual resource so that there is a much smaller amount of data to be transferred at the time of migration, thereby reducing the amount of time in which that virtual resource will be unavailable for processing. Such an approach has various drawbacks in various current approaches. For example, there may be a faster rate of data changes during operation than rate of data transfer during a pre-copy phase, such that the amount of data to be copied at migration time may not be sufficiently improved. Further, incoming data to a virtual resource can come from various other resources, devices, or sources whose rate of data transfer or generation may not be externally controllable, such that a rate limit on the virtual resource might result in a loss of data or other such issues.

### BRIEF DESCRIPTION OF THE DRAWINGS

Various embodiments in accordance with the present disclosure will be described with reference to the drawings, in which:

FIG. 1A illustrates an example datacenter system architecture in which aspects of various embodiments can be implemented, according to at least one embodiment.

FIG. 1B illustrates an example layout of components in a datacenter, according to at least one embodiment.

FIG. 2A illustrates an example migration of a virtual machine in a datacenter, according to at least one embodiment.

FIG. 2B illustrates a virtualization stack for a host machine in a datacenter, according to at least one embodiment.

FIG. 3 illustrates an example call flow during pre-copy and to determine to synchronously migrate a group of virtual resources, according to at least one embodiment.

FIG. 4A illustrates an example process that can be performed to set a dirty data rate limit for a migration of a virtual resource, according to at least one embodiment.

FIG. 4B illustrates an example process that can be performed to perform a migration of a virtual resource, according to at least one embodiment.

FIG. 5 illustrates an example datacenter system, according to at least one embodiment.

FIG. 6 is a block diagram illustrating a computer system, according to at least one embodiment.

FIG. 7 is a block diagram illustrating a computer system, according to at least one embodiment.

FIG. 8 illustrates components of an example computing system, according to at least one embodiment.

FIG. 9 illustrates components of a system including multiple processing units connected by network switches, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments provide for “live” migration of virtual computing resources, such as virtual machines (VMs), between physical resources, such as servers or host machines in a datacenter. Live migration in this context refers to migration while one or more jobs or tasks are being performed by, or able to be performed by, at least a portion of those physical resources. During processing of one or more compute jobs, it might be determined that an identified virtual machine (VM) is to be migrated. During migration, it can be beneficial to attempt to minimize the amount of time that the VM is unavailable for processing. One approach is to break the migration down into phases, such as a “pre-copy” phase and a “stop and copy” phase. During a pre-copy phase, an attempt can be made to copy as much data as possible from the current host to the new host, so that the actual time in which the VM has to be frozen for migration can be minimized. Unfortunately, since the VM continues to operate during the pre-copy phase, it is likely that at least some of the copied data will no longer be valid or current, becoming what is often referred to as “stale” or “dirty.” While additional pre-copy steps can be performed to attempt to capture and transfer these changes, it is possible that the rate of changes may meet or exceed the rate of pre-copy transfer, such that there may be no benefit gained. While it may be possible to limit the rate at which a VM (or other virtual resource) generates dirty data during a pre-copy phase, the VM may be unable to control the rate at which data (or data changes) are incoming from other components or change sources, which could result in the VM either not being able to adhere to the dirty data rate, or may result in dropped or lost data-neither of which is desirable. Approaches in accordance with various embodiments can set a dirty data rate limit to be applied during a pre-copy phase of live migration, and can set functional limits that effectively throttle other devices, even when those devices do not expose throttling capability. For example, limits may be placed on aspects such as available bandwidth for communication from a device to a VM, the speed of a network thread, or the number of available network threads, among other such options. Such approaches can help to implement a dirty data rate limit in systems with a variety of different communication devices. Further, various limits on the pre-copy phase can be implemented based in part upon these rate limits, which can help to further reduce the overall length and processing needed for a live migration of one or more virtual resources.

Variations of this and other such functionality can be used as well within the scope of the various embodiments as would be apparent to one of ordinary skill in the art in light of the teachings and suggestions contained herein.

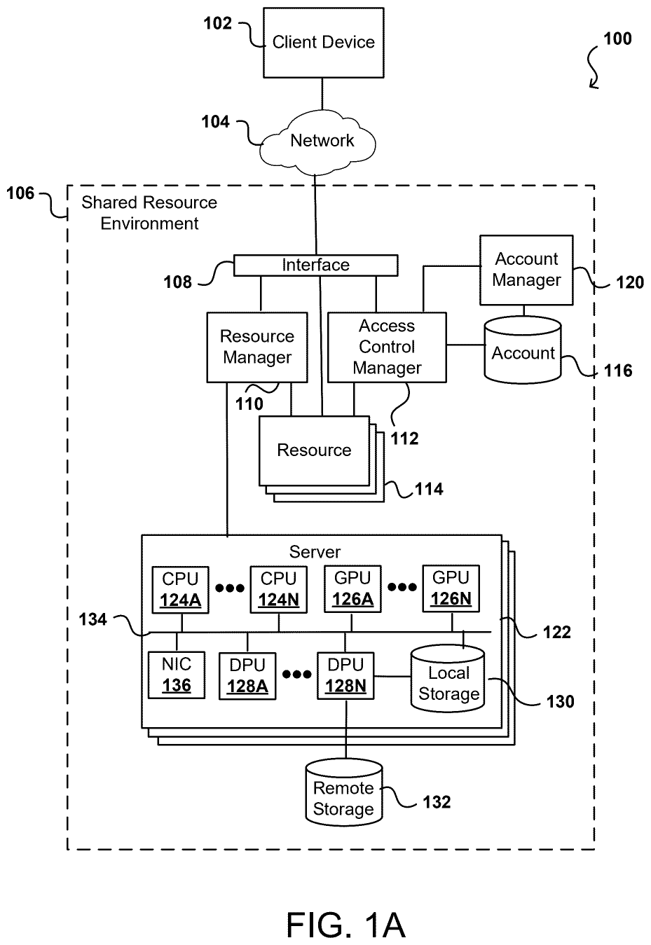

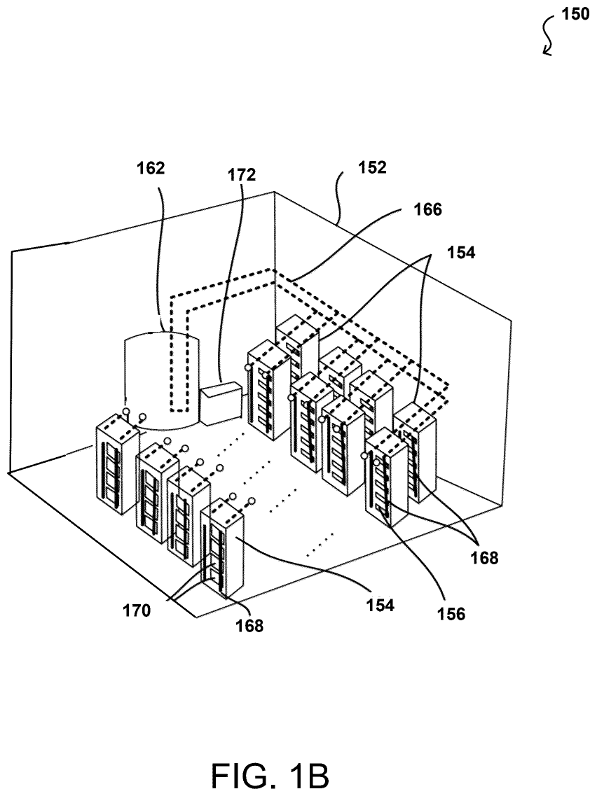

Environments such as datacenters can be used to perform various computing operations on behalf of a number of different entities, such as by using a pool of available resource capacity. FIG. 1A illustrates an example of one such architecture 100 that can be used in accordance with at least one embodiment. In this example, a user is able to use a client device 102 to submit one or more requests to access one or more resources, or to perform a task using one or more resources, among other such options. Such a request can be submitted over at least one network 104, such as the Internet or a cellular network, and received to an interface, address, or endpoint in a shared resource environment 106. The request can be received to an interface, such as an application programming interface (API) of an interface layer 108, for example, which may include other networking devices as well, as may include routers, network switches (e.g., an NV-Switch or Spectrum-X switch), load balancers, and the like. In this example, a request from a client device 102 may first need to be analyzed to determine whether the client device, user, or other entity associated with the request has access to one or more resources to be used to process the request, as well as to determine whether the type of access permitted allows for performance of the requested operation.

In this example, information for the request can be directed to an access control manager 112, or other such component, system, or service. The access control manager 112 can perform various tasks to determine and/or manage access to a set of shared resources 114, such as to extract relevant information from a received request and compare, by an account manager 120 or other such system or service, information for the request against information in an account repository 116 or other such location. If it is determined that the request is associated with a valid account, that account information can be used to determine the type of access permissible to perform one or more operations associated with the request. In some embodiments, an access control manager 112 may work with a resource manager 110 to determine a specific instance of a type of resource 114 to be used to perform an operation with respect to the request, whereas the resource manager 110 can perform other types of operations as needed, such as to allocate additional capacity of a type of resource, launch a new compute instance, or perform another such task associated with the request.

In many instances, a request that involves a number of operations to be performed may have those operations, or portions of those operations, distributed across a set of processing resources. This may include distribution across a number of physical compute resources, such as a set of shared servers, and/or may include multiple processing resources (physical or virtual) within a given physical resource. As an example, FIG. 1A illustrates example components that may be found within a given server 122 that may be allocated to perform one or more processing tasks with respect to a request. The server 122, in this instance, is illustrated to contain different types of processing units, including one or more central processing units (CPUs) 124A-124N, one or more graphics processing units (GPUs) 126A-126N, and one or more data processing units (DPUs) 128A-128N, as may be interconnected using at least one internal bus 134. At least the DPUs 128A-128N in this example may be connected to local storage 130 in the server, as well as at least one remote storage instance 132 that may be external to the server but within the shared resource environment 106. The CPUs 124A-124N are often used for tasks such as single threaded user applications, and the GPUs 126A-126N are often used to perform multiple small but related operations in parallel. DPUs can be used to offload processing tasks from these CPUs and GPUs that may not optimally be performed on these processing units, as may related to heterogeneous data-centric processing tasks that can benefit from a different type of accelerated processing. A DPU is a programmable processor or system-on-chip, which combines one or more multi-core, high-performance CPUs, a set of acceleration engines that can offload and improve performance for data-centric tasks, and one or more high-performance interfaces capable of parsing, processing, and efficiently transferring data at high speeds. A DPU can be used as a stand-alone embedded processor, or can be incorporated into a smart network interface card (SmartNIC) in a server, among other such options. An example host server 122 may include other components as well, such as at least one network interface card 136, memory, storage, peripheral devices, and the like.

In at least one embodiment, a datacenter 150 as illustrated in FIG. 1B may include one or more rooms 152 having racks 154 and auxiliary equipment to house one or more servers 170 on one or more server trays, as well as graphics processing units (GPUs) 156 and other such components. In at least one embodiment, a datacenter 150 can be supported by a cooling tower located external to the datacenter 150. A cooling tower can dissipate heat from within a datacenter 150 by acting on a primary cooling loop 166. In at least one embodiment, a cooling distribution unit (CDU) 162 is used between a primary cooling loop 166 and a secondary cooling loop, or other such heat removal mechanism. There may be cooling manifolds 168 used for individual server racks, for example, and a heat exchanger 172 or other temperature management system used to provide additional cooling and/or temperature management. Proper maintenance of such a datacenter involves not only maintenance of the computing resources, but also components and systems related to networking, power, cooling, and other such aspects. In many instances, maintenance of any one of these types of devices or systems may involve modification, at least temporarily, of one or more of these other types of devices or systems.

A manager of a datacenter, or a cloud service provider, for example, might provide physical resources that are able to execute various concurrent computing jobs using various combinations and subsets of these resources. As part of the management and maintenance of such a complex computing environment, it will often be necessary to take a physical resource offline or otherwise make a resource at least temporarily unavailable in order to perform maintenance or updates, or perform other such operations. It may also be beneficial to move virtual resources or applications between hosts for purposes such as load balancing or capacity management. In many instances, there will be one or more compute jobs executing on a host server or other compute resource that is to be taken offline. In order to avoid having to start those jobs over on another resource, or wait until the current physical resource is again available or replaced, for example, a datacenter manager may perform a migration of the processing jobs executing on that resource, along with any virtual resources (e.g., virtual machines VMs) that are executing those jobs. In many instances, a user associated with a “guest” VM will be unaware of the hardware being used to perform a compute job, such that the user will not care if the job is migrated to another resource, and also may not be aware of the migration. As long as the migration is performed without significant delay or increase in latency, the migration may be performed in a seamless manner without a user being able to even determine that a migration occurred.

When performing such a migration, in many instances it will be necessary (or at least advantageous) to use the same type of hardware for a given job or virtual resource before, and after, the migration. For example, if a VM is running on a first server that has a network interface card (NIC) and a graphics processing unit (GPU) configured in a certain way to support specific operations or communications, it can be advantageous to migrate the VM to a second server that includes a similar NIC and GPU with similar configurations, in order to avoid the need for reconfiguration or modification, as well as to ensure that the VM operates properly on the new server, among other such advantages. Processes such as pass-through device migration can be used to, for example, migrate a VM that is using a pass-through device, such as a NIC, from one physical server to another while maintaining active connectivity. A migration manager can manage various aspects of the migration, such as to perform reconnection and resumption after migration of the VM. After migration and resumption, the VM should be able to continue working in the same way on the new server as on the prior server. In many instances, the servers in a datacenter will all be connected to a datacenter-wide network as may be provided using a set of Ethernet cables and switches.

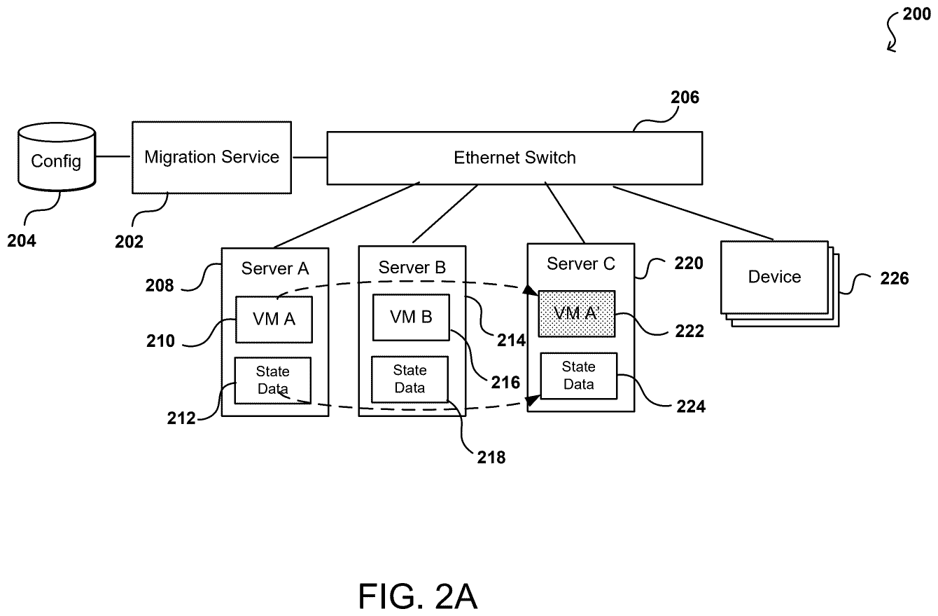

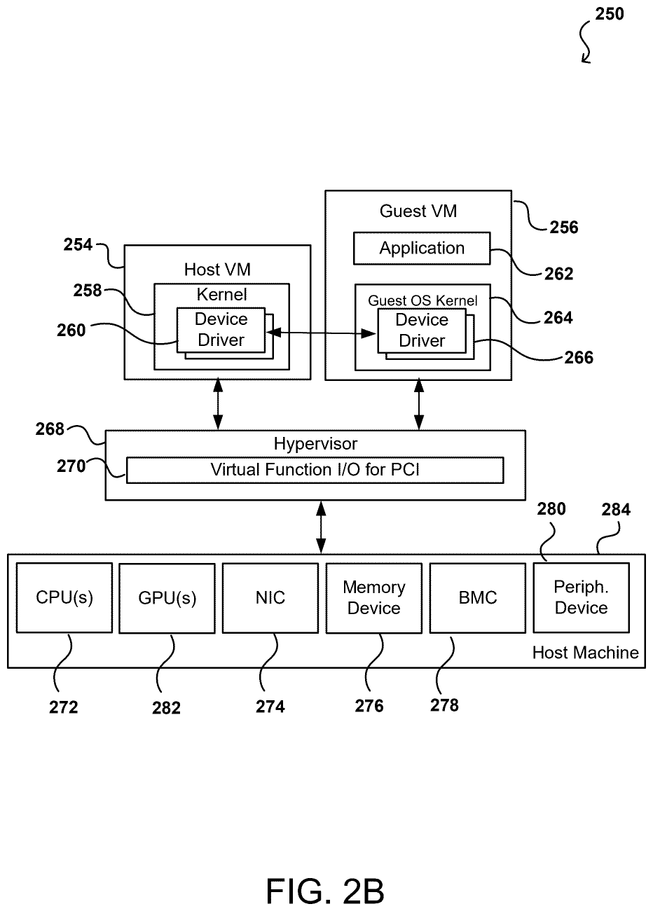

FIG. 2A illustrates a view of an example system 200 that can operate in a complex computing environment, such as a datacenter, in accordance with various embodiments. It should be understood that such an environment can include various other resources and components (e.g., routers and load balancers, server racks, and other components such as those discussed with respect to FIGS. 1A and 1B) not illustrated in FIG. 2A, and that a selection of components was chosen for ease of explanation. In this example, there are three host servers 208, 214, 220 that are able to perform processing jobs as part of the complex computing environment. These can include independent jobs, or respective portions of a distributed compute job, among other such options. In this example, each server can be able to communicate with every other server using network connections for a network of the computing environment, such as an Ethernet network provided using various Ethernet connections and at least one Ethernet switch 206. There may also be other networks provided in such an environment that may only be available for subsets of resources.

In one example, host server A 208 might host a current version of a guest VM (VM A 210), and will store some amount of state data 212 stored by and/or used with that VM A 210. The current VM 210 might communicate with other devices on the host server 208, such as a GPU or NIC. The current VM 210 might also communicate with another VM (VM B 216) on another host server (server B 214) that has different state data 218 stored for that VM, and may communicate with other devices across the Ethernet network (or other such network) as well. It is possible that any of these other devices or VMs can communicate with the current VM 210 in a way that results in modification of the current state data 212 stored for that VM 210.

During (or before) processing of a job, there may be an issue detected with at least one of the physical resources hosting one or more virtual machines that might cause a migration service 202 to initiate a migration. Such an issue may include, for example, an error detected with the hosting server, a need to update or modify the hosting server, or a determination of insufficient capacity of the hosting server, among other such options. In this example, a migration service 202 may determine (as may be based on monitored information, or a notification from a resource manager or other such component or service, etc.) that VM A 2210 needs to be, or would at least benefit from being, migrated from server A to another host server. A migration service 202 can determine, based upon information from a configuration repository 204 or one or more migration agents on the host servers, for example, that server C 220 has a configuration and aspects similar to those of server A 208, as well as sufficient availability and/or capacity, and can be used as a new host server for VM A 210 without significant reconfiguration or adjustment of the server, VM, or related components or devices. The migration service 202 in this example can then issue a command to migrate the current VM A 210 from current host server A 208 to a new instance of the VM A′ 222 on new host server C 220. The migration can include migration of the VM, as well as migration of the associated state data.

In one example, such migration may be performed while the current VM A 210 is currently performing at least one job, or is at least available to perform such a job. As discussed, such migration can then be referred to as a “live” migration. A live migration can involve movement of one or more resources, such as a guest virtual machine (VM) or other virtual resource, from a first physical host, where the guest VM is currently hosted and operating, to a second physical host. In this example, a VM A 210 is to be live migrated from a current host server A 208 to a new host server C 220. In many instances, this migration should occur with minimal (if any) disruption to various operations involving (or otherwise impacted by) the current VM A 210, also referred to as a “guest” VM hosted on a host server. Such migration should also occur with minimal (if any) adverse effects for an end user, or other party to an operation performed by the guest VM. Migration may be performed for any of a number of beneficial reasons, such as for load balancing, fault tolerance, or energy saving purposes. Migration may also be performed beneficially to improve hardware independence, or for geographic diversity of operations, among other such reasons. In at least one embodiment, migration works by sending the state data 212 of the guest virtual machine's memory and any virtualized devices to a destination host physical machine, such as server C 220. Migrations can be performed live or not, and in the live case the migration should not disrupt the user operations and can be transparent as explained in the sections below. A VM after migration should still be able to operate in the same manner in many instances, including communicating to the same communication partners, such as VM B 216 on server B 214, and one or more devices 226 accessible via the Ethernet switch 206, among other such options.

FIG. 2B illustrates an example virtualization stack 250 that can be implemented on a host machine according to at least one embodiment. Such a virtualization stack 250 can be used to provide an allocated environment for a user (or guest or customer of a resource provider) having an operating system provisioned on the resource. In accordance with the illustrated embodiment, the vitalization stack 250 can include a number of hardware resources on a given host machine 284, such as one or more central processing units (CPUs) 272, one or more graphics processing units (GPUs) 282, one or more network interface cards (NICs), one or more memory devices 276 (e.g., RAM or flash memory), a board management controller (BMC) 278, and one or more peripheral devices 280, among other such options. In some embodiments, at least some of these hardware resources may reside off the host machine 284. A virtual resource stack can run on top of the hardware resources of the host machine 284. A virtual resource stack may include a virtualization layer such as a hypervisor 268 for a Xen-based implementation, which may include one or more virtual functions 270 for PCI-based input/output (I/O) data operations. Those operations may involve communication with a host virtual machine (VM) 254 sitting on the hypervisor 268, as well as one or more guest VMs 256 capable of executing at least one application 262. The hypervisor 268, if utilized for a virtualized environment, can manage execution of the one or more guest operating systems and allow multiple instances of different operating systems to share the underlying hardware resources of the host machine 284. A hypervisor can also allow for the execution of guest operating systems as part of the guest VMs 256, where the guest operating systems themselves can act as servers.

In the example of FIG. 2B, a hypervisor 268 can host a number of VMs (or domains), including the host VM 254 and one or more guest VMs 256. The host VM 254 (as may correspond to the Dom-0) can be the first VM or first domain created, such that it can help to virtualize hardware resources and manage other VMs or domains running on the hypervisor 268. For example, the host VM 254 can manage the creating, destroying, migrating, saving, or restoring the one or more guest VMs 256 (as may correspond to the Dom-U). In accordance with various embodiments, the hypervisor 268 can control access to the hardware resources such as the CPU 272, input/output (I/O) memory device 276, and hypervisor memory.

A guest VM 256 can include one or more virtualized or para-virtualized drivers 266 and the host VM 254 can include one or more backend device drivers 260. When the operating system (OS) kernel 264 in the guest VM 256 attempts to invoke an I/O operation, a virtualized driver 266 may perform the operation by way of communicating with a corresponding backend device driver 260 in a kernel 258 on the host VM 254. When the guest driver 266 attempt to initiate an I/O operation (e.g., to send out a network packet), a guest kernel component can identify which physical memory buffer contains the packet (or other data) and the guest driver 266 can either copy the memory buffer to a temporary storage location in the kernel for performing I/O or obtain a set of pointers to the memory pages that contain the packet(s). These locations or pointers can be provided to the backend driver 260 of the host VM 254, which can obtain access to the data and communicate it directly to the host machine 284, such as the NIC 274 for sending the packet over the network.

It should be noted that the resource stack 250 illustrated in FIG. 2B is only one possible example of a set of resources that is capable of providing a virtualized computing environment and that the various embodiments described herein are not necessarily limited to this particular resource stack. In some embodiments, a guest VM 256 may have bare metal access to the NIC 274 hardware, as may be provided by device assignment technology based on an IO Memory Management Unit (IO-MMU) device mapping. In such an implementation, there may be no virtualization layer (e.g., Hypervisor) present. The host domain, or OS, may then be provided by the user, with no guest domains utilized. Other technologies, such as Single Root IO Virtualization (SR-IOV), may provide similar “bare metal” functionality to guest VMs 256 for at least some functionality of the devices. In general, in various other embodiments, the resource stack may comprise different virtualization strategies, hardware devices, operating systems, kernels, domains, drivers, hypervisors, and other resources. As mentioned, during migration of a guest VM 256 it can be important to migrate the guest VM 256 to a similar host machine 284 with similar resources and a similar virtualization stack 250, in order to allow the guest VM after migration to resume operation without significant modification or updating of the guest VM or related components or processes.

As mentioned, a guest VM 256 during operation will have at least some data stored, such as in a memory device 276. In order to avoid a loss of data during live migration, a guest VM (or other device) can be stopped or paused so that there is no risk of the migrated and resumed VM using stale or outdated data that was otherwise updated during the migration process. Accordingly, a guest VM can be paused (or stopped, frozen, or suspended, etc.) so that no more data updates occur, and then the guest VM can be migrated after the guest VM is paused. Referring back to FIG. 2A, the state data 212 stored for the guest VM at the time of the pausing can also be copied over to a new collection of state data 224, so that when the guest VM resumes operation on the new host 220, the “new” guest VM will have the same data as it had before the pause operation. As mentioned, however, this may result in a large amount of data to be transferred between hosts. As the amount of data increases, the time needed to transfer the data will typically also go up accordingly. If a large amount of data is to be transferred during the migration, that may result in an unacceptable amount of latency for the migration. During this period, a user will be unable to access the guest VM, and the guest VM will be unable to perform (or continue to perform) any operations, so in essence, the guest VM will be frozen during the migration operation.

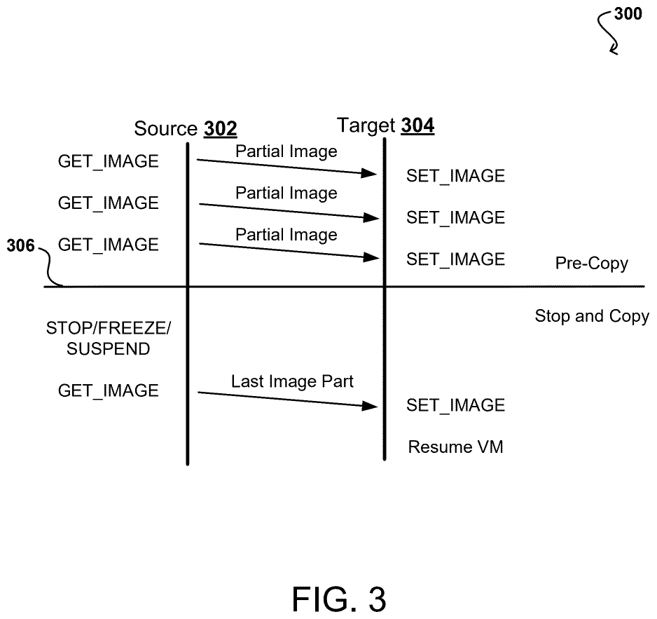

In order to minimize (or at least significantly minimize) the amount of time for a migration of a guest VM between hosts, at least some amount of data can be copied over before the guest VM is paused or stopped for the migration. During a pre-copy phase of a migration, a guest VM can be operational and can continue to process data. The virtualization software (e.g., a hypervisor) can transfer data for the guest VM to the corresponding virtualization software (e.g., a hypervisor) on the target host for the migration. FIG. 3 illustrates an example data copying flow 300 for an example migration process according to at least one embodiment. In this example, the source 302 of data corresponds to the current guest VM on the current host. In this example, a new guest VM can be created or instantiated on the new host as the target 304 for the data transfer. The data transfer can occur in both a pre-copy stage and a stop and copy phase, where a transition point 306 between the phases is determined according to one or more criteria. During a pre-copy stage, a GET_IMAGE call can be used to get the current data (image) from the current guest VM, which can be analyzed to identify a portion of that data that is to be transmitted to the target 304 during pre-copy stage, and a partial image can be transmitted to the target. This allows the pre-copied data to be available to the new host and to the guest VM, so that the new guest VM can resume from the same state as the prior guest VM on the prior host. Each partial image can represent incremental image changes since the last save, last partial image transfer, or a remaining portion of the data that is determined to be available for pre-copy, where the data image can be obtained from a device on the current host, such as the host device itself, the CPU, or the RAM, among other such option.

After a phase transition criterion is satisfied, the current VM is paused (or frozen or suspended, etc.) on the current host, the virtualization software can issue another GET_IMAGE (or similar) request on to get the data for the current guest VM, can determine a remaining (or updated) portion of that data that needs to be sent to the target 304, and can generate a last partial image to send, to the target host, the remaining/updated portion of the virtualization state data (or other relevant data) that was changed or otherwise not transferred during the pre-copy phase. The last image part, as well as each of the partial images, can be stored to a similar device or component, such as the target host device, or a CPU or RAM on the target host device.

In an ideal world, a pre-copy stage would copy over as much data as possible before a pause operation, so that a minimal amount of time is needed for the migration and the guest VM will be unavailable for a minimal amount of time. Since the guest VM will be in operation during the pre-copy stage, however, there may be continual updates to the data such that any pre-copied data may no longer be current. These “stale” pages (or images or collections) of data are often referred to as “dirty” pages, as they are no longer clean copies of the current state of the relevant data. After some amount or period of updating, another partial image can be generated and transferred from the source 302 to the target 304 over one or more iterations. Each iteration can include a more recent partial image that can be used to update the state (or other) data stored to the target. The continual updating of data can make it difficult to pre-copy all data before a stop-and-copy stage of a migration, as some of the data for the current guest VM is likely to change after the prior state of the data has been pre-copied over to the new host. If a migration process were not allowed to proceed until all possible data had been pre-copied, as this may result in an endless (or at least unacceptably long) process when the data is being continually modified. Accordingly, there can be a threshold or rule set in place that indicates the point 306 at which the pre-copy phase should end. This may include, for example, a maximum length of time (e.g., 60 seconds), a maximum amount of pre-copy data transfer, or a number of page iterations due to changes, among other such options. Another example, approach can indicate that the migration should move to a stop-and-copy stage once the amount of data that remains to be transferred, after the pre-copy phase has executed for a period of time, is less than a maximum data threshold, such as less than a specified number of bytes left to be transferred. The maximum data threshold can be adjustable and set based on any of a number of factors, such as available bandwidth, service level agreements, maximum latency thresholds, and the like. As mentioned, one or more thresholds or criteria can be set to attempt to keep the stop and copy phase as short as possible, such as by transferring as little data as possible, in order to minimize the length of time that the corresponding guest VM is unavailable for data processing or other such operations.

If a criterion used to determine when to transition from a pre-copy phase to a stop-and-copy (or similar) phase is size or volume-based, then the amount of data to be copied over should decrease over time. In other words, for every iteration or updated page of data to be copied over, the amount of data to be copied (or moved) should decrease, at least on average. One way to accomplish this is for the average data transfer rate during a pre-copy phase to be greater than the average rate at which “dirty” data is generated by the guest VM, or the average rate at which already-copied data becomes stale. When the migration is to occur on a single device with no other entities communicating, this can involve modifying the operation rate of a single device or system, which may be possible in many situations. For networked situations involving multiple parties or devices, however, there will often be no ability to modify the operational rate of a remote and/or separate device. Such networked situations may then require different approaches to indirectly reduce the performance of a related device.

As an example, data for a guest VM may be updated by a CPU on a host device. In order to limit the rate at which the CPU can update data for the guest VM, or otherwise generate “dirty” data, it would be possible to reduce the speed or frequency of the CPU. A CPU running at a slower speed will tend to also dirty memory at a slower speed. In some instances where the CPU supports other VMs on the host machine, or performs other operations, it may be undesirable to significantly reduce the speed of the CPU. Further, one or more of the devices that generate dirty data for a guest VM may operate in an asynchronous manner, such that these devices do not interact with the CPU and anything affecting the CPU is not necessarily affecting these devices. As a result, the CPU may need to operate at full speed to avoid a loss or corruption of data transmitted to the CPU by these other devices.

Approaches in accordance with various embodiments can provide mechanisms that can be used to throttle a device that may operate in an asynchronous manner without intervention by, for example, a processor such as a central processing unit (CPU). Example devices that can be throttled in this way can include, without limitation, graphics processing units (GPUs), data processing units (DPUs), remote direct memory access (RDMA) devices, and network interface cards (NICs), among other such options. Throttling can be used to attempt to ensure convergence during a pre-copy (or similar) stage of migration, where, for convergence, a pre-copy rate should be higher than the total dirty rate for copied data so that the amount of data to be transferred for each pre-copy iteration decreases over time. The total dirty rate can be composed of, for example, a virtual CPU (vCPU) dirty rate plus a per-device dirty rate.

In at least one embodiment, an attempt can be made to throttle the dirty device rate, instead of directly throttling a given device or component. For example, before (or at a time of) entering a pre-copy phase, virtualization software (e.g., a hypervisor) can set a limit on a dirty rate of a device. A dirty rate limit can, in effect, cause the device to slow down its operation so as to not exceed that limit. In order to remain within this limit, a corresponding device may need to have certain functionality (or work with such functionality), such as to be able to monitor its current “dirty” rate, whether that be dirty pages, dirty data, or any other determined or specified metric. This dirty rate can also be monitored for various virtual functions, such as per SRIOV function, or per sub-entity, etc. The migration system can also advantageously be able to perform functionality such as to be able to “slow down” (or reduce the modification of data by) hardware entities such as hardware threads of a limited device or entity, or to be able to allocate less and/or fewer hardware resources, such as hardware threads allocated for a limited entity, among other such options.

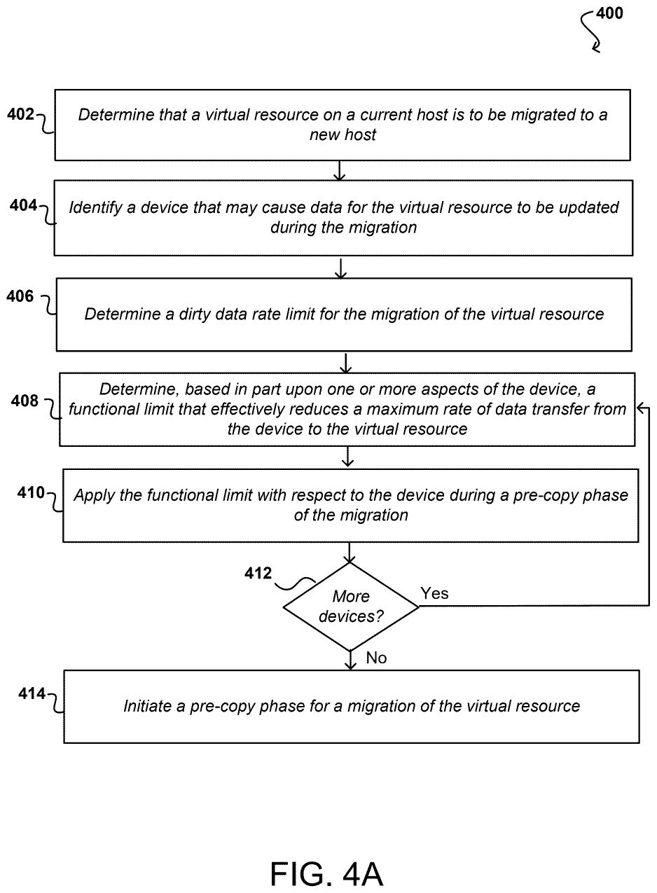

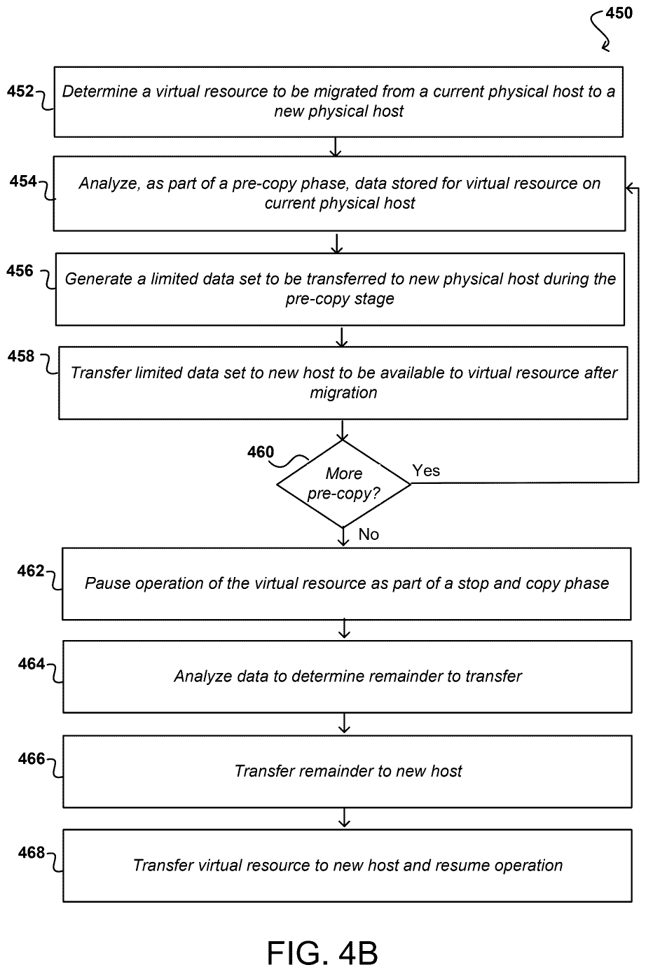

FIG. 4A illustrates an example process 400 that can be performed to implement a dirty rate limit for a migration of a virtual resource (e.g., a guest VM), according to at least one embodiment. It should be understood that for this and other processes presented herein that there may be additional, fewer, or alternative steps performed or similar or alternative orders, or at least partially in parallel, within the scope of the various embodiments unless otherwise specifically stated. In this example, it can be determined 402 that a virtual resource on a current host machine is to be migrated to a new host machine. Migration may be performed for any of a number of reasons, as may relate to maintenance, load management, or other such factors. Before migration is performed, at least one device can be identified 404 that may cause data for the virtual resource to be updated during the migration. A dirty data rate limit can also be determined 406 or specified for the migration of the virtual resource, which can help to ensure that the rate of dirty data generation is significantly less than the rate of data transfer during a pre-copy phase. The rate can be a factor of network bandwidth, allowable time for pre-copy, and other such aspects. For the identified device, a functional limit can be determined 408, based in part on one or more aspects of the device, that effectively limits a maximum rate of data transfer (or other data manipulation) from the device to the virtual resource. For example, the limit may be determined based in part upon the type of device, capabilities of the device, and methods of communication used by the device. For example, if a CPU communicates over a network connection, then the limit may impact the available bandwidth of the network connection, or may impact the speed or number of threads that can be used for network communication, among other such options. This functional limit, once determined, can be applied 410 with respect to the device during a pre-copy phase of the migration. In this way, the dirty data rate of the device will be less than the rate of data transfer for the migration, even if the device is unable to have its rate directly manipulated or if there are devices that operate in an asynchronous manner and could otherwise require a higher dirty data rate. A determination can be made 412 as to whether there are more devices to be limited, as the total dirty data rate for a virtual resource can be a factor of the incoming data from more than one communicating device. If so, the process can continue for the next device. If it is determined 412 that there are no more devices that may need to be limited, then a pre-copy phase can be initiated 414 for a migration of the virtual resource.

In some embodiments, a device to be limited can include (or correspond to) a general (or non-specialized) asynchronous acceleration device, such as a GPU. A general asynchronous will typically not include a networking interface, but can operate in an asynchronous manner from a corresponding CPU. Such an acceleration device can have its dirty rate for a function limited in a number of ways as well, such as by reducing the internal hardware threads allocated for the function. This can also be accomplished by reducing the speed of the internal hardware threads allocated for the function, or reducing the bus speed (e.g., PCIe speed). In one example, a workload may be launched on a GPU that is able to operate asynchronously from a CPU, and thus dirty pages at its own rate. In order to reduce the dirty rate of the GPU, the frequency and/or number of hardware threads used for that workload can be reduced (at least in the case of multi-threaded workloads). Such an approach can effectively reduce the dirty pages of the asynchronous device by reducing the speed or number of other resources used by the asynchronous device that results in dirty pages.

As mentioned, in some embodiments a device to be limited may also be a device that is accessible over at least one network, as will be referred to herein as a “network device.” When using data transmitted by a network device, there may be a high frequency or rate of incoming data packets. This may include, for example, incoming RDMA writes which are operating on the memory and dirtying the memory at a high rate. Once these packets are received, it is too late to limit the transmission rate as the transmission has already occurred, and dropping received packets can be undesirable for a number of different reasons. In such a situation, it is not enough to attempt to limit operation of a guest VM, for example, but it may be necessary to also attempt to limit the devices that send data to the guest VM (or limit the data that can be transmitted by those network devices to the guest VM). In at least one embodiment, the dirty rate of a network device can be limited by limiting the function bandwidth of that device. This can be accomplished by, for example, reducing the network interface speed, reducing the internal hardware threads allocated for the function, or reducing the speed of the internal hardware threads allocated for the function. This can also be accomplished by reducing the interface internal NIC buffers used for transmitting, reducing the bus speed (e.g., the PCIe speed), or reducing the speed of the peers transmitting to the network device (which can also require a mechanism to report the limit for the other peers in at least one embodiment). In one embodiment, the size of the memory or port buffers can be reduced that are used by the network device to be limited.

In some embodiments, it may be beneficial to limit the bandwidth for peers over a peer network. This may include an in-band option, where an interface sends probes or messages to a peer device to attempt to limit the bandwidth of that device, as may be implemented similar to various congestion control mechanisms. This may include, for example, sending an in-band message to all peers on a single communication channel indicating that a VM has established a limit, and request that those peer devices implement a similar limit when communicating with that VM. For an out-of-band option, the virtualization software (e.g., hypervisor) may query the interface for peer devices and deliver, for the virtualization software on each relevant peer device, a message or information regarding the limit. The virtualization software on the peer device can deliver the limit to the peer device, which can then have the capability to limit itself. For example, a hypervisor on a guest VM can send a message to other hypervisors across the network to request to implement a limit when communicating with the guest VM. In at least one embodiment, such a limit is only to be applied to connections that are connected to the migrating VM, and not for other connections to other devices or VMs, etc. The options available or beneficial for these and other such situations can depend at least in part upon the functionality available and/exposed by the relevant hardware and/or software.

As mentioned, such an approach allows for limiting a dirty rate for one or more devices that otherwise require intervention by a processing unit (such as a virtual CPU). As mentioned, this can include, for example and without limitation, devices such as RDMA capable NICs or GPUs. Use cases for such devices include a guest VM being a target for RDMA WRITE operations or a GPU having an asynchronous kernel running, such as an asynchronous CUDA kernel from NVIDIA Corporation.

The values for any rate limiting thresholds or criteria can depend in part on the type of hardware or device, capabilities of that hardware or device, and the criteria used for the pre-copy phase, among other such options. As mentioned, it is desired for the pre-copy stage to converge, which can require that the dirtying of data be less than the transfer rate of the data during the pre-copy stage. Thus, a limit may be specified that causes the dirtying rate to be lower, by at least a specified amount, than the transfer rate capability for a given device in a given system. Further, if it is desired to have a relatively short pre-copy phase, then the difference between the possible dirtying rate and the transfer rate may be relatively large. For devices that are not able to be directly limited, the amount by which to reduce bandwidth or a number of threads, among other such options discussed herein, may have values set accordingly. There may also be some amount of monitoring, and dynamic adjustments to such values. For example, if it is determined that a device is dirtying 1,000 pages on average over a period of time, which is resulting in an excessive amount of data being transferred in each pre-copy iteration, then the system might ask that the device reduce its dirtying rate to a lower value, such as to dirty around 500 pages on average over that same period of time. It may then be up to the other device, or a component managing that other device, to determine the appropriate adjustment(s) to only dirty that reduced number of pages. Certain types of monitoring may be difficult, however-such as to attempt to identify unique addresses and generate corresponding value histograms over a sliding window of time. Instead, approaches in accordance with at least one embodiment may attempt to leverage metrics that are less complicated and time-consuming, such as bandwidth over PCI or a network port, or the frequency or occupancy of a device, among other such options. The logic used to make such determinations and/or adjustments, as well as monitoring functionality, can sit in the hardware device itself, such as in the NIC or GPU in hardware or firmware. The logic as to the values to limit, as well as when to limit or adjust those values, can sit in the virtualization software running on a hypervisor, for example. Monitoring can be implemented for any appropriate metric, such as PCI bandwidth, function network bandwidth, number of dirty memory addresses, and the like. The monitoring may not be able to provide that data along with time information, but the sampling frequency can be used to convert this information into rate information.

FIG. 4B illustrates an example process 450 that can be performed to migrate a virtual resource, according to at least one embodiment. In this example, a virtual resource (e.g., a guest VM) is determined 452 to be migrated from a current physical host to a new physical host. In this case, the migration is a live migration that will involve a pre-copy phase, during which time the virtual resource will continue to operate, and a stop-and-copy phase. As part of the pre-copy phase, the current set of state (and other relevant) data stored for the virtual resource on the current host can be analyzed 454, such as to determine which of the data can be copied over to the new host during the pre-copy phase. A limited data set can be generated 456 to include the data that is able to be copied over, and for subsequent iterations, the data that has not already been copied over or that has been modified since prior copy. This limited data set can then be transferred 458 over to the new physical host during this pre-copy phase.

As mentioned, the virtual resource being migrated may continue to operate during the pre-copy phase. Accordingly, some of the data stored for that virtual resource may change as the limited data is determined and transferred. As a result, there may be multiple pre-copy transfers of limited data sets performed to attempt to transfer as much data as possible before operation of the virtual resource is stopped for migration. In order to avoid an unnecessarily long pre-copy phase, however, there may be one or more limits placed on the pre-copy stage, as may relate to a maximum length of time or maximum number of transfer iterations, or may relate to the size of the remaining amount of data to be transferred among other such options. If, using such a criterion, it is determined 460 that there is more pre-copying (i.e., another pre-copy iteration) to be performed, then the process can continue with generating a new limited data set to be transferred to the new host, which can contain any updated transferrable data or data not transferred to the new host in a prior iteration. If it is determined 460 that no further iterations are to be performed, such as where an end criterion has been satisfied, then the pre-copy phase of the migration can end and a stop-and-copy phase can be initiated. After this change in phase, operation of the virtual resource can be paused 462 (or frozen or stopped) to avoid further dirtying of data during the migration process. The stored data for the virtual resource can be analyzed 464 to determine the remainder of the state data that is to be transferred. This remaining data can then be transferred 466 to the new host to be used by the virtual resource after migration. The virtual resource can be transferred 468 as well, to be hosted on the new host. After the data and virtual resource are ready on the new host, operation of the virtual host can be resumed on the new host, with the transferred data already in place so the virtual resource can resume from the same state as when the virtual resource was paused on the prior host.

A resume operation can perform various operations as may be necessary for continued processing, which may include creating virtual functions for various hardware devices. For example, a migration process might start up a virtual GPU instance to support a migrated VM on a given host. A migration manager, which knows the network topology and configuration, can also be responsible for connecting the VM to the virtual GPU, as well as any necessary NICs, CPUs, DPUs, or other such components. A given hardware resource may have multiple NICs that communicate with multiple limited networks, and a migration manager can ensure that a given virtual resource is connected to the appropriate NICs and/or networks. Migration can also potentially be optimized for specific types of combinations of hardware or networks.

### Datacenter

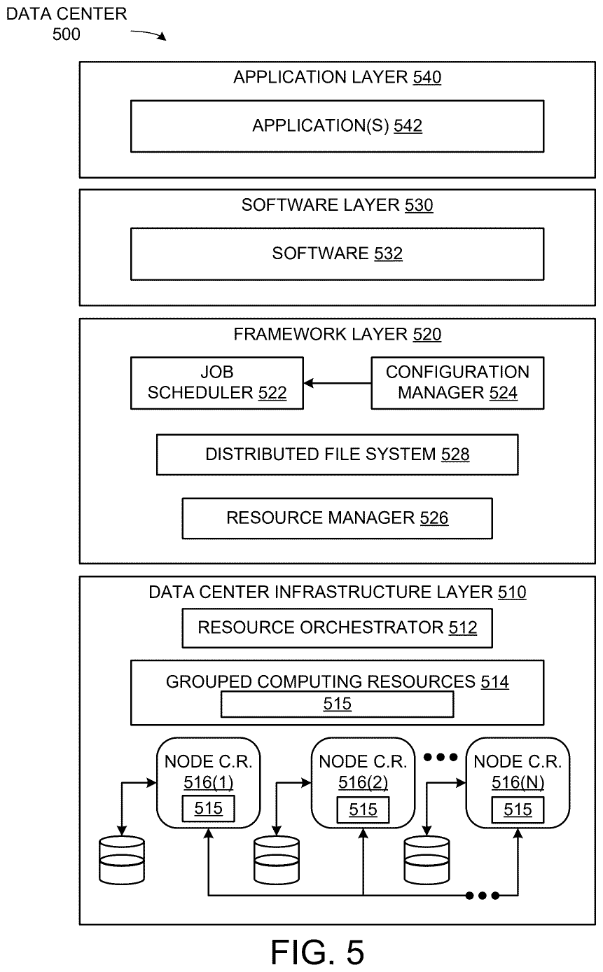

FIG. 5 illustrates the architecture of an example datacenter 500, in which at least one embodiment may be implemented. In at least one embodiment, data in this datacenter 500 includes a datacenter infrastructure layer 510, a framework layer 520, a software layer 530, and an application layer 540.

In at least one embodiment, as shown in FIG. 5, datacenter infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-516(N) may be a server having one or more of above-mentioned computing resources.

In at least one embodiment, grouped computing resources 514 may include separate groupings of node C.R.s housed within one or more racks (not shown), or many racks housed in datacenters at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for datacenter 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of datacenter 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at datacenter infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a datacenter operator of datacenter 500 from making possibly bad configuration decisions and possibly avoiding underutilized and/or poor performing portions of a datacenter.

In at least one embodiment, datacenter 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 500. In at least one embodiment, trained machine learning models corresponding to one or more neural networks may be used to infer or predict information using resources described above with respect to datacenter 500 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can allow for live migration of virtual resources including a pre-copy phase with dirty data rate limits applied.

### Computer Systems

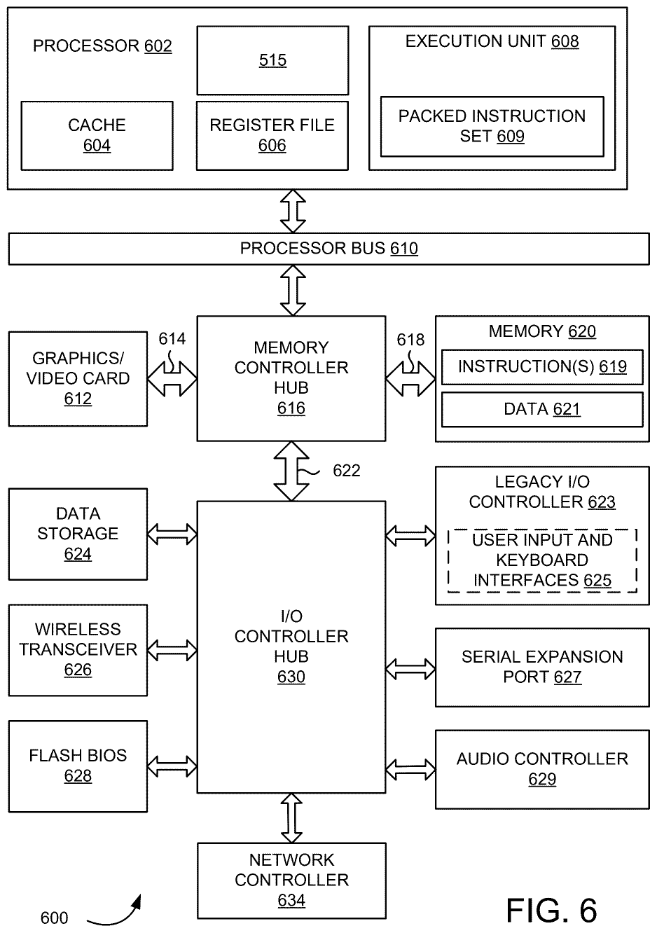

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high speed I/O bus for connecting peripherals to memory 620, a chipset, and processor 602. Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 illustrates an exemplary SoC. In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can allow for live migration of virtual resources including a pre-copy phase with dirty data rate limits applied.

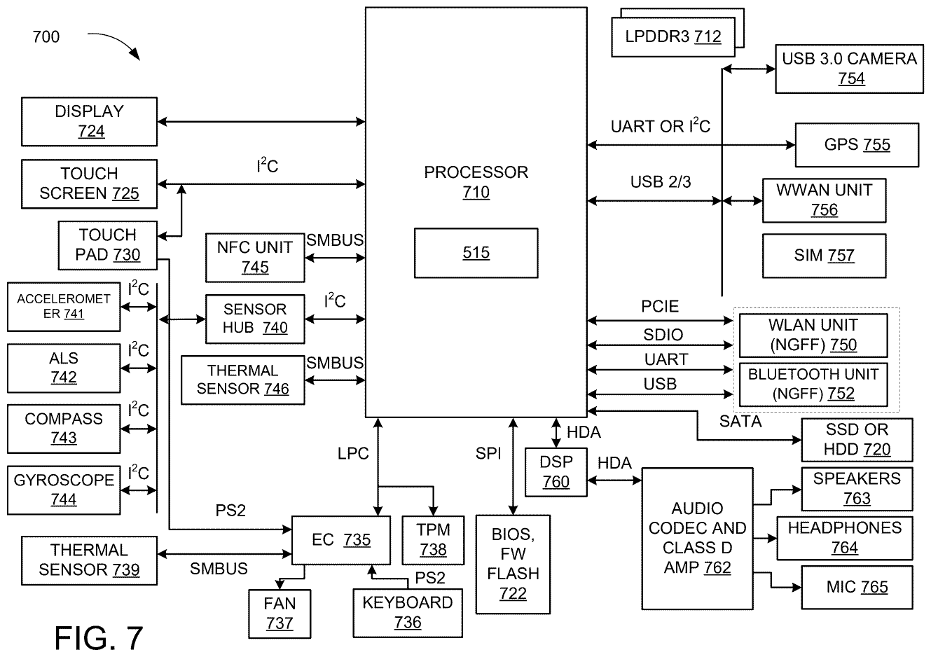

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can allow for live migration of virtual resources including a pre-copy phase with dirty data rate limits applied.

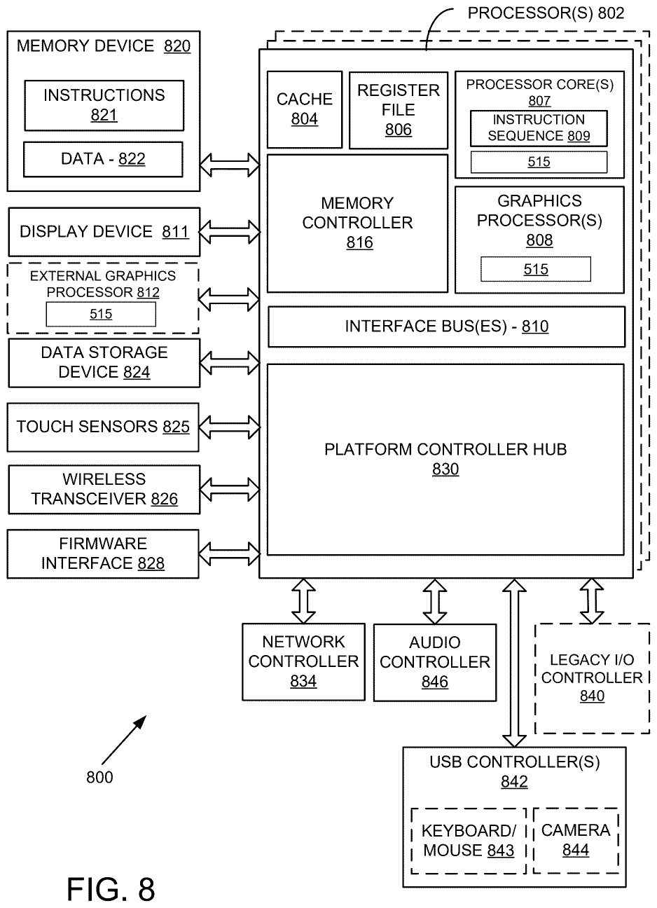

FIG. 8 is a block diagram of a processing system, according to at least one embodiment. In at least one embodiment, system 800 includes one or more processor(s) 802 and one or more graphics processor(s) 808, and may be a single processor desktop system, a multiprocessor workstation system, or a server system having a large number of processor(s) 802 or processor core(s) 807. In at least one embodiment, system 800 is a processing platform incorporated within a system-on-a-chip (SoC) integrated circuit for use in mobile, handheld, or embedded devices. In at least one embodiment, one or more graphics processor(s) 808 include one or more graphics cores.

In at least one embodiment, system 800 can include, or be incorporated within a server-based gaming platform, a game console, including a game and media console, a mobile gaming console, a handheld game console, or an online game console. In at least one embodiment, system 800 is a mobile phone, a smart phone, a tablet computing device or a mobile Internet device. In at least one embodiment, processing system 800 can also include couple with, or be integrated within a wearable device, such as a smart watch wearable device, a smart eyewear device, an augmented reality device, or a virtual reality device. In at least one embodiment, processing system 800 is a television or set top box device having one or more processor(s) 802 and a graphical interface generated by one or more graphics processor(s) 808.

In at least one embodiment, one or more processor(s) 802 each include one or more processor core(s) 807 to process instructions which, when executed, perform operations for system and user software. In at least one embodiment, each of one or more processor core(s) 807 is configured to process a specific instruction sequence 809. In at least one embodiment, instruction sequence 809 may facilitate Complex Instruction Set Computing (CISC), Reduced Instruction Set Computing (RISC), or computing via a Very Long Instruction Word (VLIW). In at least one embodiment, processor core(s) 807 may each process a different instruction sequence 809, which may include instructions to facilitate emulation of other instruction sequences. In at least one embodiment, processor core(s) 807 may also include other processing devices, such a Digital Signal Processor (DSP).

In at least one embodiment, processor(s) 802 includes a cache memory 804. In at least one embodiment, processor(s) 802 can have a single internal cache or multiple levels of internal cache. In at least one embodiment, cache memory is shared among various components of processor(s) 802. In at least one embodiment, processor(s) 802 also uses an external cache (e.g., a Level-3 (L3) cache or Last Level Cache (LLC)) (not shown), which may be shared among processor core(s) 807 using known cache coherency techniques. In at least one embodiment, a register file 806 is additionally included in processor(s) 802, which may include different types of registers for storing different types of data (e.g., integer registers, floating point registers, status registers, and an instruction pointer register). In at least one embodiment, register file 806 may include general-purpose registers or other registers.

In at least one embodiment, one or more processor(s) 802 are coupled with one or more interface bus(es) 810 to transmit communication signals such as address, data, or control signals between processor(s) 802 and other components in system 800. In at least one embodiment, interface bus(es) 810 can be a processor bus, such as a version of a Direct Media Interface (DMI) bus. In at least one embodiment, interface bus(es) 810 is not limited to a DMI bus, and may include one or more Peripheral Component Interconnect buses (e.g., PCI, PCI Express), memory busses, or other types of interface busses. In at least one embodiment processor(s) 802 include an integrated memory controller 816 and a platform controller hub 830. In at least one embodiment, memory controller 816 facilitates communication between a memory device and other components of system 800, while platform controller hub (PCH) 830 provides connections to I/O devices via a local I/O bus.

In at least one embodiment, a memory device 820 can be a dynamic random access memory (DRAM) device, a static random access memory (SRAM) device, flash memory device, phase-change memory device, or some other memory device having suitable performance to serve as process memory. In at least one embodiment, memory device 820 can operate as system memory for system 800, to store data 822 and instructions 821 for use when one or more processor(s) 802 executes an application or process. In at least one embodiment, memory controller 816 also couples with an optional external graphics processor 812, which may communicate with one or more graphics processor(s) 808 in processor(s) 802 to perform graphics and media operations. In at least one embodiment, a display device 811 can connect to processor(s) 802. In at least one embodiment, display device 811 can include one or more of an internal display device, as in a mobile electronic device or a laptop device, or an external display device attached via a display interface (e.g., DisplayPort, etc.). In at least one embodiment, display device 811 can include a head mounted display (HMD) such as a stereoscopic display device for use in virtual reality (VR) applications or augmented reality (AR) applications.

In at least one embodiment, platform controller hub 830 enables peripherals to connect to memory device 820 and processor(s) 802 via a high speed I/O bus. In at least one embodiment, I/O peripherals include, but are not limited to, an audio controller 846, a network controller 834, a firmware interface 828, a wireless transceiver 826, touch sensors 825, a data storage device 824 (e.g., hard disk drive, flash memory, etc.). In at least one embodiment, data storage device 824 can connect via a storage interface (e.g., SATA) or via a peripheral bus, such as a Peripheral Component Interconnect bus (e.g., PCI, PCI Express). In at least one embodiment, touch sensors 825 can include touch screen sensors, pressure sensors, or fingerprint sensors. In at least one embodiment, wireless transceiver 826 can be a Wi-Fi transceiver, a Bluetooth transceiver, or a mobile network transceiver such as a 3G, 4G, or Long Term Evolution (LTE) transceiver. In at least one embodiment, firmware interface 828 enables communication with system firmware, and can be, for example, a unified extensible firmware interface (UEFI). In at least one embodiment, network controller 834 can enable a network connection to a wired network. In at least one embodiment, a high-performance network controller (not shown) couples with interface bus(es) 810. In at least one embodiment, audio controller 846 is a multi-channel high definition audio controller. In at least one embodiment, system 800 includes an optional legacy I/O controller 840 for coupling legacy (e.g., Personal System 2 (PS/2)) devices to system 800. In at least one embodiment, platform controller hub 830 can also connect to one or more Universal Serial Bus (USB) controller(s) 842 connect input devices, such as keyboard and mouse 843 combinations, a camera 844, or other USB input devices.

In at least one embodiment, an instance of memory controller 816 and platform controller hub 830 may be integrated into a discreet external graphics processor, such as external graphics processor 812. In at least one embodiment, platform controller hub 830 and/or memory controller 816 may be external to one or more processor(s) 802. For example, in at least one embodiment, system 800 can include an external memory controller 816 and platform controller hub 830, which may be configured as a memory controller hub and peripheral controller hub within a system chipset that is in communication with processor(s) 802.

Embodiments presented herein can allow for live migration of virtual resources including a pre-copy phase with dirty data rate limits applied.

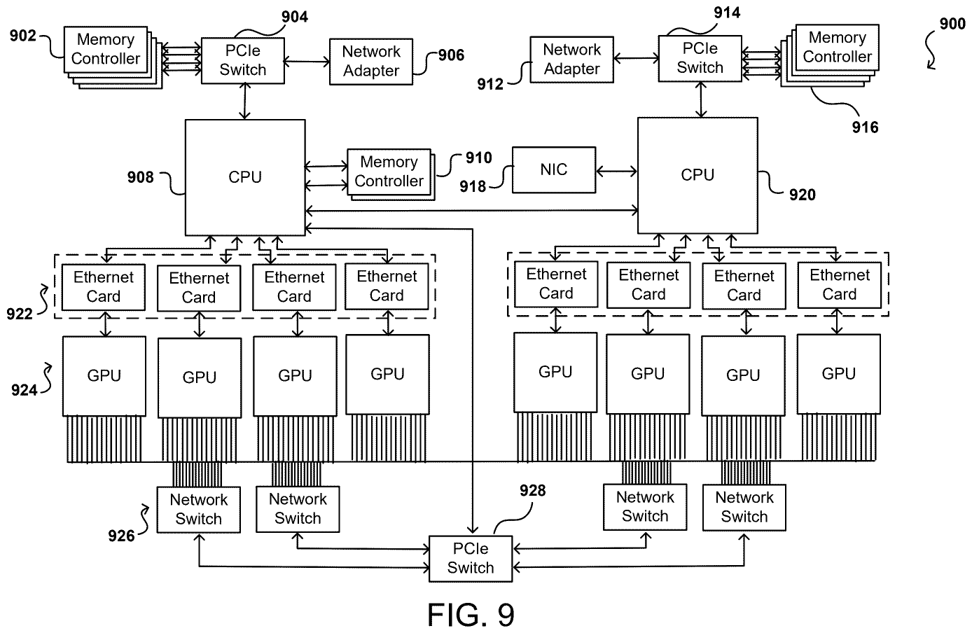

FIG. 9 illustrates an example enterprise AI system that can be used to perform at least AI-related tasks in accordance with at least one embodiment. An example of such a system is an H100 or H200 DGX system implementing the NVIDIA DGX™ platform from NVIDIA Corporation. The NVIDIA DGX™ H100/H200 Systems are built for all AI infrastructure and workloads from analytics to training to inference. The DGX H100/H200 systems are built on eight GPUs 924, such as NVIDIA H100 Tensor Core GPUs or eight NVIDIA H200 Tensor Core GPUs. Although not illustrated in FIG. 9, other types of processing units can be used as well, such as data processing units (DPUs). The illustrated system 900 includes a pair of CPUs 908, 920, such as Intel Xeon CPUs with 56 cores each. The CPUs 908, 920 are connected to the eight GPUs 924 using a set of Ethernet cards 922, such as ConnectX-7 Network Modules, which are connected in turn to a number of network switches 926, such as NVSwitches. The network switches 926 are connected to a PCIe switch 928, which can be connected back to at least one of the CPUs 908. A first CPU 908 can be connected directly to a memory controller 910, such as an NVMe controller, and to other memory controllers 902 indirectly through a PCIe switch 904, which can also connect the CPU 908 to a network adapter 906, such as a ConnectX-7 adapter. A second CPU 920 can be connected to the first CPU 908 as well as a network interface card (NIC) 918. The second CPU 920 can also be connected, through another PCIe switch 914, to a network adapter 912 and one or more memory controllers 916.

An example Nvidia DGX (Deep GPU Xceleration) implementation can include a number of servers and workstations that are geared towards enhancing deep learning applications through the use of general-purpose computing on graphics processing units (GPUs). Such systems may come in a rackmount format featuring high-performance x86 server CPUs on the motherboard. A core feature of an example DGX system is its inclusion of 8 or more NVIDIA GPU modules, which are housed on an independent system board. These GPUs can be connected either via a version of the SXM socket or a PCIe x16 slot, facilitating flexible integration within the system architecture. To manage the substantial thermal output, DGX units are equipped with heatsinks and fans designed to maintain optimal operating temperatures. This framework makes DGX units suitable for computational tasks associated with artificial intelligence and machine learning models. In one embodiment, the GPUs can be connected using an NVLink mesh network.

Embodiments presented herein can allow for live migration of virtual resources including a pre-copy phase with dirty data rate limits applied.

Various embodiments can be described by the following clauses:
1. A system, comprising:
a plurality of host machines capable of hosting a virtual resource and storing data for the virtual resource; and
a migration manager to determine to migrate a virtual resource from a first host to a second host of the plurality of host machines, the migration manager further to:
set a maximum dirty data rate limit for the virtual resource in order to cause an amount of data for the virtual resource, to be copied over during individual iterations of a pre-copy operation, to be less than an amount of dirty data generated by the virtual resource during a respective iteration;
perform one or more iterations of the pre-copy operation to transfer, from the first host to the second host, data that has not yet been copied to the second host in a current state;
after a remaining amount of data for the virtual resource to be transferred to the second host is determined to be less than a maximum size threshold, stop operation of the virtual resource;
migrate the virtual resource, and the remaining amount of data, from the first host to the second host; and
resume operation of the virtual resource on the second host using the data for the virtual resource copied from the first host.
2. The system of clause 1, wherein the migration manager is further to:
identify a device in communication with the virtual resource that is able to modify the data stored to the first host during the individual iterations of the pre-copy operation; and
apply one or more limits to prevent a rate of data modification caused by the device from exceeding the maximum dirty data rate.
3. The system of clause 2, wherein the device is a graphics processing unit (GPU), a data processing unit (DPU), or a network interface card (NIC).
4. The system of clause 2, wherein the one or more limits applied to the device include at least one of a maximum amount of available bandwidth, a number of available hardware threads, a bus speed limit, or a maximum available thread speed.
5. The system of clause 1, wherein the migration manager is further to ensure a maximum dirty data rate for migration of the virtual resource by applying one or more limits to each of a plurality of devices able to modify the data stored to the first host during the individual iterations of the pre-copy operation.
6. The system of clause 1, wherein the maximum dirty rate limit is determined by a hypervisor operating on the first host.
7. The system of clause 1, wherein the migration manager is further to monitor a dirty data rate associated with the migration and adjust one or more limits to modify cause the dirty data rate to remain under the maximum dirty data rate.
8. The system of clause 1, wherein the migration manager is further to monitor the dirty data rate for each of a plurality of single root input/output virtualization SRIOV functions.
9. The system of clause 1, wherein the operation of the virtual resource, and the iterations of the pre-copy operation, is further able to be stopped in response to a maximum amount of time or a maximum number of pre-copy operations in a pre-copy phase of the migration.
10. The system of clause 1, wherein the maximum dirty data rate is determined using a dirty data rate of a virtual CPU and a dirty data rate of at least one asynchronous device in communication with the virtual resource.
11. The system of clause 1, wherein a dirty rate of a network device is able to be limited by limiting at least one of a function bandwidth, a network interface speed, an internal buffer used for transmitting, a bus speed, or a peer speed transmission rate.
12. The system of clause 1, wherein a dirty rate of a network device is able to be limited for an in-band option by causing an interface to send probes or messages to a peer device to attempt to limit a bandwidth of the device, and able to be limited for an out-of-band option by causing virtualization software to query interfaces for peer devices and deliver, for virtualization software on each relevant peer device, a message or information regarding the limit, wherein the virtualization software on the peer device is able to deliver the limit to the peer device.
13. A system, comprising one or more processing units to migrate a virtual resource from a first host to a second host by, in part, copying a portion of data for the virtual resource to the second host during one or more iterations of a pre-copy phase, during which time a maximum dirty data rate is implemented for modification of the data on the first host, and subsequently pausing operation of the virtual resource to migrate the virtual resource, and any remaining data from the resource, to the second host before resuming operation of the virtual resource.
14. The system of clause 13, wherein the one or more processing units are further to apply one or more limits to one or more devices in communication with the virtual resource in order to maintain a dirty data rate for the virtual resource below the maximum dirty data rate.
15. The system of clause 14, wherein the maximum dirty data rate is less than a transfer rate of data from the first host to the second host during the pre-copy phase.
16. The system of clause 14, wherein the one or more devices include at least one of a GPU, a DPU, or a NIC.
17. The system of clause 14, wherein the one or more limits applied to the one or more devices include at least one of a limit on available bandwidth, a number of available hardware threads, a maximum available thread speed, a function bandwidth, a network interface speed, an internal buffer used for transmitting, a bus speed limit, or a peer speed transmission rate.
18. at Least One Processor, Comprising:
one or more logical units to apply a maximum dirty data rate for a virtual resource to be live migrated from a first host to a second host, and monitor a dirty data rate during a pre-copy phase of live migration to ensure that an asynchronous device, in communication with the virtual resource over a network, does not cause the dirty data rate to exceed the maximum dirty data rate.
19. The at least one processor of clause 18, wherein the asynchronous device includes at least one of a GPU, a DPU, or a NIC.
20. The at least one processor of clause 18, wherein the pre-copy phase includes one or more iterations of data copy, and wherein one or more iterations include updated data with respect to a previous iteration.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
a plurality of host machines capable of hosting a virtual resource and storing data for the virtual resource; and
a migration manager to determine to migrate a virtual resource from a first host to a second host of the plurality of host machines, the migration manager further to:
set a maximum dirty data rate limit for the virtual resource in order to cause an amount of data for the virtual resource, to be copied over during individual iterations of a pre-copy operation, to be less than an amount of dirty data generated by the virtual resource during a respective iteration;
perform one or more iterations of the pre-copy operation to transfer, from the first host to the second host, data that has not yet been copied to the second host in a current state;
after a remaining amount of data for the virtual resource to be transferred to the second host is determined to be less than a maximum size threshold, stop operation of the virtual resource;
migrate the virtual resource, and the remaining amount of data, from the first host to the second host; and
resume operation of the virtual resource on the second host using the data for the virtual resource copied from the first host.

2. The system of claim 1, wherein the migration manager is further to:
identify a device in communication with the virtual resource that is able to modify the data stored to the first host during the individual iterations of the pre-copy operation; and
apply one or more limits to prevent a rate of data modification caused by the device from exceeding the maximum dirty data rate.

3. The system of claim 2, wherein the device is a graphics processing unit (GPU), a data processing unit (DPU), or a network interface card (NIC).

4. The system of claim 2, wherein the one or more limits applied to the device include at least one of a maximum amount of available bandwidth, a number of available hardware threads, a bus speed limit, or a maximum available thread speed.

5. The system of claim 1, wherein the migration manager is further to ensure a maximum dirty data rate for migration of the virtual resource by applying one or more limits to each of a plurality of devices able to modify the data stored to the first host during the individual iterations of the pre-copy operation.

6. The system of claim 1, wherein the maximum dirty rate limit is determined by a hypervisor operating on the first host.

7. The system of claim 1, wherein the migration manager is further to monitor a dirty data rate associated with the migration and adjust one or more limits to modify cause the dirty data rate to remain under the maximum dirty data rate.

8. The system of claim 1, wherein the migration manager is further to monitor the dirty data rate for each of a plurality of single root input/output virtualization SRIOV functions.

9. The system of claim 1, wherein the operation of the virtual resource, and the iterations of the pre-copy operation, is further able to be stopped in response to a maximum amount of time or a maximum number of pre-copy operations in a pre-copy phase of the migration.

10. The system of claim 1, wherein the maximum dirty data rate is determined using a dirty data rate of a virtual CPU and a dirty data rate of at least one asynchronous device in communication with the virtual resource.

11. The system of claim 1, wherein a dirty rate of a network device is able to be limited by limiting at least one of a function bandwidth, a network interface speed, an internal buffer used for transmitting, a bus speed, or a peer speed transmission rate.

12. The system of claim 1, wherein a dirty rate of a network device is able to be limited for an in-band option by causing an interface to send probes or messages to a peer device to attempt to limit a bandwidth of the device, and able to be limited for an out-of-band option by causing virtualization software to query interfaces for peer devices and deliver, for virtualization software on each relevant peer device, a message or information regarding the limit, wherein the virtualization software on the peer device is able to deliver the limit to the peer device.

13. A system, comprising one or more processing units to migrate a virtual resource from a first host to a second host by, in part, copying a portion of data for the virtual resource to the second host during one or more iterations of a pre-copy phase, during which time a maximum dirty data rate is implemented for modification of the data on the first host, and subsequently pausing operation of the virtual resource to migrate the virtual resource, and any remaining data from the resource, to the second host before resuming operation of the virtual resource.

14. The system of claim 13, wherein the one or more processing units are further to apply one or more limits to one or more devices in communication with the virtual resource in order to maintain a dirty data rate for the virtual resource below the maximum dirty data rate.

15. The system of claim 14, wherein the maximum dirty data rate is less than a transfer rate of data from the first host to the second host during the pre-copy phase.

16. The system of claim 14, wherein the one or more devices include at least one of a GPU, a DPU, or a NIC.

17. The system of claim 14, wherein the one or more limits applied to the one or more devices include at least one of a limit on available bandwidth, a number of available hardware threads, a maximum available thread speed, a function bandwidth, a network interface speed, an internal buffer used for transmitting, a bus speed limit, or a peer speed transmission rate.

18. At least one processor, comprising:
one or more logical units to apply a maximum dirty data rate for a virtual resource to be live migrated from a first host to a second host, and monitor a dirty data rate during a pre-copy phase of live migration to ensure that an asynchronous device, in communication with the virtual resource over a network, does not cause the dirty data rate to exceed the maximum dirty data rate.

19. The at least one processor of claim 18, wherein the asynchronous device includes at least one of a GPU, a DPU, or a NIC.

20. The at least one processor of claim 18, wherein the pre-copy phase includes one or more iterations of data copy, and wherein one or more iterations include updated data with respect to a previous iteration.
